(19) United States
(12) Patent Application Publication
(10) Pub. No.: US 2010/0185606 A1
(43) Pub. Date: Jul. 22, 2010

(54) DEVELOPMENT DOCUMENT DATA MANAGEMENT DEVICE, DEVELOPMENT DOCUMENT DATA MANAGEMENT SYSTEM, DEVELOPMENT DOCUMENT DATA MANAGEMENT METHOD, PROGRAM THEREFOR, AND RECORDING MEDIUM

(75) Inventors: Tomohiro Kakiuchi, Osaka (JP); Shiori Asai, Osaka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/665,880

(22) PCT Filed: Jun. 26, 2008
(86) PCT No.: PCT/JP2008/001663

§ 371 Date: Dec. 21, 2009

(30) Foreign Application Priority Data
Jul. 12, 2007 (JP) 2007-182909

(51) Int. Cl. G06F 17/30

(52) U.S. Cl. 707/723; 707/758; 707/E17.014

(57) ABSTRACT

A development document data management device includes a storage section and a control section. The storage section stores product document data, and document data attribute information including a commercialization stage indicating any one of two or more stages to develop the product and a type indicating which type the aim of the document data generated in the commercialization stage is related to, for each of the document data. The control section operates to calculate a total point from a stage-specific point given to the commercialization stage and a type point given to the type based on the document data attribute information, to generate document data management information associating the total point with the document data; and to display search results of the document data management information based on the search condition when the search condition for searching the document data is inputted in a predetermined order.

### TECHNICAL FIELD

The present invention relates to a development document data management device, a development document data management system, and a development document data management method, for registering document data used for development and document data attribute information on the document data and searching desired document data based on the document data attribute information, a program therefor, and a storage medium.

### BACKGROUND ART

When a defect occurs in a product provided widely in the market, it is necessary to take measures against the defect. However, it is a difficult work to quickly and exactly extract relevant document data from an enormous amount of document data formed in each stage (hereinafter, referred to as a “commercialization stage”) from planning of the product to mass production.

This is because such document data are formed by many persons in charge, and a person understanding all the document data does not exists. As a result, when document data are searched, a person in charge of taking measures against a defect may not notice the presence of relevant document data even if they are present.

Thus, in order to efficiently search document data formed in the stages of designing and development of such a product, a method of registering and managing such document data in a computer is carried out.

An example of a method of efficiently searching document data includes a method of storing documents (corresponding to “document data” of the present invention) and a keyword group including information on a designer such that they are associated with each other, and using this keyword group as a search key (see, patent document 1).

Furthermore, a method of adding drawing attribute data such as a production line name, a work name, and a facility name to drawings (corresponding to “document data” of the present invention) registered in a computer, and using the drawing attribute data attribute information as a search key has been considered (see, patent document 2).

[Patent document 1] Japanese Patent Unexamined Publication No. 2006-195836

[Patent document 2] Japanese Patent Unexamined Publication No. 2005-135118

### SUMMARY OF THE INVENTION

A development document data management device of the present invention includes a storage section and a control section.

The storage section stores a plurality of document data on a product, and document data attribute information including a commercialization stage indicating any one of two or more stages to develop the product and a type indicating any one of a plurality of types the aim of the document data generated in the commercialization stage is related to, for each of the document data.

The control section operates so as to calculate a total point from a stage-specific point given to the commercialization stage and a type point given to the types based on the document data attribute information; to generate document data management information for associating the total point with the document data; and to display results of search of the document data management information in a predetermined order based on a search condition when the search condition for searching the document data is inputted.

Thus, when various formats of document data including drawing, table, and the like, are searched, such document data can be searched by using such an objective index as a point converted from various information of document data attribute information without using an ambiguous index such as a keyword.

### BRIEF DESCRIPTION OF THE DRAWINGS

FIG. 1 is a configuration view showing hardware of a development document data management system in accordance with a first exemplary embodiment of the present invention.

FIG. 2 is a configuration view showing hardware of a development document data management system in accordance with the first exemplary embodiment of the present invention.

FIG. 3 is a configuration view showing hardware of a development document data management system in accordance with the first exemplary embodiment of the present invention.

FIG. 4 is a function block diagram showing a development document data management device in accordance with the first exemplary embodiment of the present invention.

FIG. 5 is a hierarchy view showing a relation between a commercialization stage in the product development and a type of document data in accordance with the first exemplary embodiment of the present invention.

FIG. 6A is a view showing a data configuration of document data management information in accordance with the first exemplary embodiment of the present invention.

FIG. 6B is a view showing a data configuration of document data management information in accordance with the first exemplary embodiment of the present invention.

FIG. 7 is a hierarchy view showing a correlation of products in accordance with the first exemplary embodiment of the present invention.

FIG. 8 is a view showing a data configuration of correlation information in accordance with the first exemplary embodiment of the present invention.

FIG. 9 is a view showing a data configuration of target range information in accordance with the first exemplary embodiment of the present invention.

FIG. 10 is a view showing a data configuration of type point information in accordance with the first exemplary embodiment of the present invention.

FIG. 11 is a view showing a data configuration of stage-specific point information in accordance with the first exemplary embodiment of the present invention.

FIG. 12 is a view showing a data configuration of mutual point information in accordance with the first exemplary embodiment of the present invention.

FIG. 13 is a view showing a data configuration of reference information in accordance with the first exemplary embodiment of the present invention.

FIG. 14 is a view showing a data configuration of type reference ratio information in accordance with the first exemplary embodiment of the present invention.

FIG. 15 is a view showing a data configuration of stage-specific reference ratio information in accordance with the first exemplary embodiment of the present invention.

FIG. 16 is a flowchart to illustrate a process of registering the document data and the document data management information in accordance with the first exemplary embodiment of the present invention.

FIG. 17 is a flowchart to illustrate a process of searching the document data in accordance with the first exemplary embodiment of the present invention.

FIG. 18A is a view to illustrate a screen for searching document data in accordance with the first exemplary embodiment of the present invention.

FIG. 18B is a view to illustrate a screen for searching document data in accordance with the first exemplary embodiment of the present invention.

FIG. 18C is a view to illustrate a screen for searching document data in accordance with a second exemplary embodiment of the present invention.

FIG. 19A is a view to illustrate a screen of search results of document data in accordance with the first exemplary embodiment of the present invention.

FIG. 19B is a view to illustrate a screen of search results of document data in accordance with the first exemplary embodiment of the present invention.

FIG. 20 is a flowchart showing a point update processing based on the reference information in accordance with the first exemplary embodiment of the present invention.

FIG. 21 is a view showing a data configuration of the updated type point information in accordance with the first exemplary embodiment of the present invention.

FIG. 22 is a view showing a data configuration of the updated stage-specific point information in accordance with the first exemplary embodiment of the present invention.

FIG. 23 is a view showing a data configuration of type point information set for each defect pattern in accordance with the second exemplary embodiment of the present invention.

FIG. 24 is a view showing a data configuration of stage-specific point information set for each defect pattern in accordance with the second exemplary embodiment of the present invention.

FIG. 25 is a view showing a data configuration of reference information in accordance with the second exemplary embodiment of the present invention.

FIG. 26 is a view showing a data configuration of the type reference ratio information for every defect pattern in accordance with the second exemplary embodiment of the present invention.

FIG. 27 is a view showing a data configuration of the stage-specific reference ratio information for every defect pattern in accordance with the second exemplary embodiment of the present invention.

FIG. 28 is a view showing a data configuration of updated type point information in accordance with the second exemplary embodiment of the present invention.

FIG. 29 is a view showing a data configuration of updated stage-specific point information in accordance with the second exemplary embodiment of the present invention.

FIG. 30 is a hierarchy view showing a correlation of a product in accordance with a third exemplary embodiment of the present invention.

FIG. 31 is a view showing a data configuration of reference information in accordance with the third exemplary embodiment of the present invention.

FIG. 32 is a view showing a data configuration of mutual reference ratio information in accordance with the third exemplary embodiment of the present invention.

FIG. 33 is a function block diagram showing a development document data management device in accordance with the third exemplary embodiment of the present invention.

### REFERENCE MARKS IN THE DRAWINGS

1 document data registering device
4 document data searching device
6 communication line
9, 9a, 9b storage section
10 point information calculating section
11, 11a, 11b control section
15 point updating section
16 extraction result receiving section
30 document data
31 document data attribute information
32 document data management information
33 correlation information
34 target range information
35, 135, 235, 335 type point information
36, 136, 236, 336 stage-specific point information
37 mutual point information
38, 238, 338 reference information
39, 239 type reference ratio information
40, 240 stage-specific reference ratio information
54 extraction result
100 development document data management device
101 development document data management system

### DETAILED DESCRIPTION OF THE PREFERRED EMBODIMENT

Hereinafter, a development document data management device, a development document data management system and a development document data management method in accordance with exemplary embodiments of the present invention are described with reference to attached drawings.

An example mentioned below shows a case in which document data are extracted in a product in which a defect occurs.

Each of the below-mentioned exemplary embodiments is an example of the embodiment of the present invention and does not intend to limit the technical range of the present invention.

### First Exemplary Embodiment

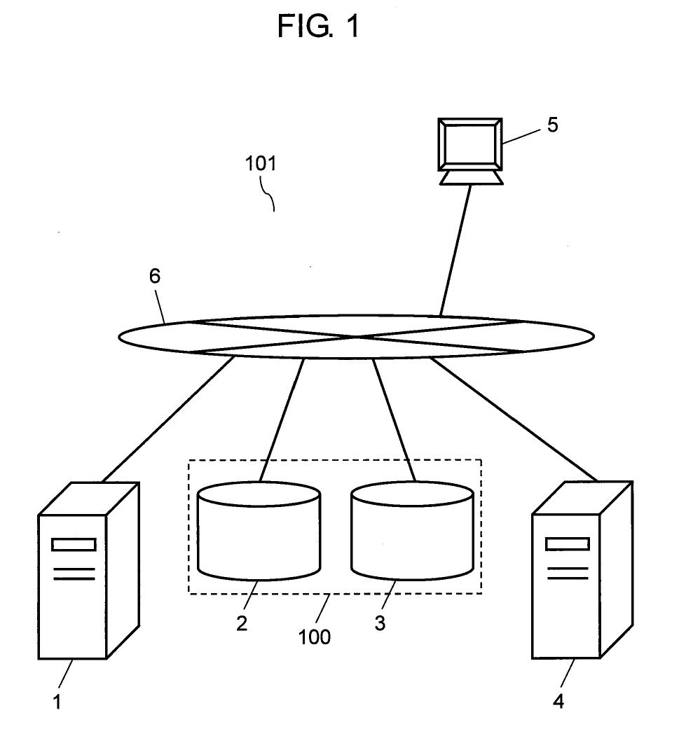

FIG. 1 is a configuration view showing hardware of a development document data management system in accordance with one exemplary embodiment of the present invention.

As shown in FIG. 1, development document data management system 101 in accordance with the exemplary embodiment of the present invention includes document data registering device 1, development document data management device 100 including document data storing device 2 and document data management information storing device 3, and document data searching device 4, which are connected to user terminal 5 via communication line 6. Communication line 6 may be wired or wireless.

Furthermore, when the communication line is wired, it may be a telecommunication line used for the Internet or may be a communication line using a cable, such as IEEE 1394.

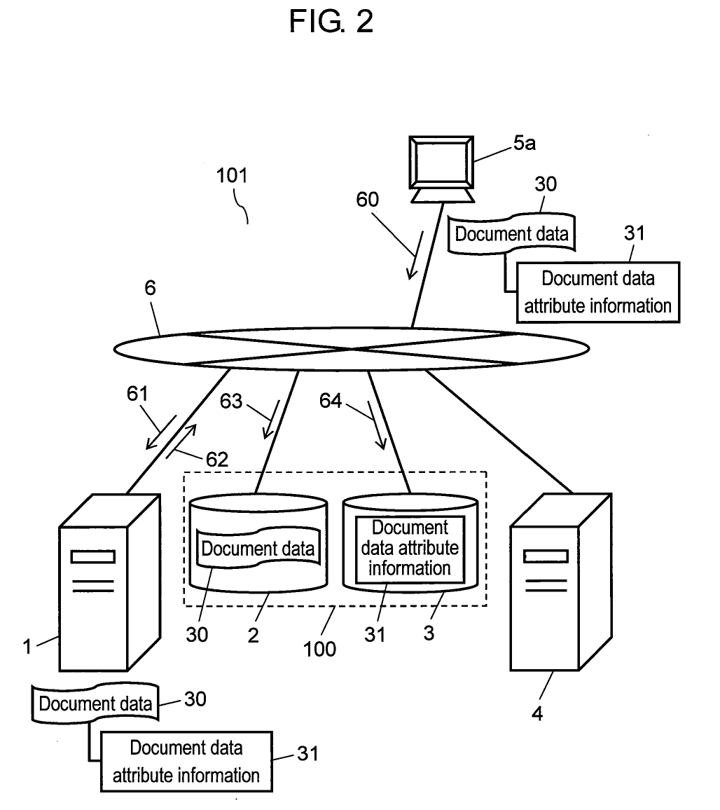

Next, a procedure for storing document data 30 by using such a development document data management system 101 is described with reference to FIG. 2.

As shown in FIG. 2, development document data management device 100 stores document data 30 and document data attribute information 31.

Document data 30 in the exemplary embodiment of the present invention are intended to include a wide range of materials related to a product.

Specifically, the document data include various kinds of documents used from the start of development of a product to production, sales, after-sales service, and the like. An example of such documents includes a planning paper, a specification, and a design drawing, which are described later.

The storage form of document data 30 is not particularly limited and may include paper information, microfilm, electronic data, or the like. In the description below, electronic data are used as an example of document data 30.

Furthermore, document data attribute information 31 shows positioning of each document data 30 from the development of a product to the after-sales service, and the like.

In this exemplary embodiment, document data attribute information 31 includes a commercialization stage showing a stage of product development and a type showing an aim of each document data 30.

User terminal 5a shown in FIG. 2 is an input device for inputting document data 30 and document data attribute information to development document data management device 100 in accordance with the exemplary embodiment of the present invention.

Firstly, a user of development document data management system 101 (hereinafter, referred to as a “user”) transmits document data 30 and document data attribute information 31 from user terminal 5a as an input device to document data registering device 1 via communication line 6 (arrows 60 and 61 in FIG. 2).

Next, document data registering device 1 transmits document data 30 in the received data to document data storing device 2 (arrows 62 and 63 in FIG. 2) and document data attribute information 31 in the received data to document data management information storing device 3 (arrows 62 and 64 in FIG. 2).

Thereafter, document data storing device 2 stores the received document data 30, and document data management information storing device 3 stores the received document data attribute information 31, respectively.

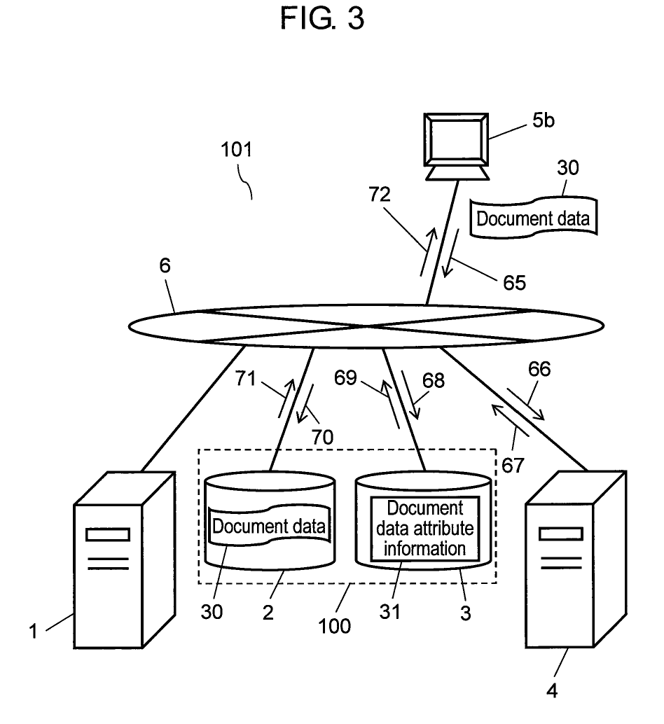

Next, a procedure for searching document data 30 stored in document data storing device 2 with the use of document data attribute information 31 stored in document data management information storing device 3 is described with reference to FIG. 3.

User terminal 5b shown in FIG. 3 is a search condition input device for inputting a search condition for searching document data 30 to development document data management device 100 in accordance with the exemplary embodiment of the present invention, and a user carrying out searching by using development document data management system 101 inputs a predetermined search condition into user terminal 5b.

The input search condition is transmitted to document data searching device 4 via communication line 6 (arrows 65 and 66 in FIG. 3).

Document data searching device 4 searches document data 30 suitable for a user's request by using document data attribute information 31 stored in document data management information storing device 3 based on the received search conditions (arrows 67 and 68 in FIG. 3).

Next, document data storing device 2 extracts document data 30 based on the result of search of document data management information storing device 3, and transmits the extracted document data 30 to user terminal 5b via document data searching device 4 (arrows 69, 70, 71, 66, and 72 in this order in FIG. 3).

Note here that for document data registering device 1, document data storing device 2, document data management information storing device 3 and document data searching device 4, a special-purpose computer may be used or a general purpose computer having CPU (Central Processing Unit), RAM (Random Access Memory), ROM (Read Only Memory), HDD (Hard Disk Drive), communication function, and the like, may be used.

Furthermore, document data storing device 2 may be a file server or a CAD server.

Similarly, for user terminals 5 (5a to 5c), a special-purpose computer may be used or a general-purpose computer having an input part such as a keyboard and a mouse and a display part such as a liquid crystal display or a CRT display in addition to CPU, RAM, ROM, HDD, communication function, and the like, may be used.

Next, a development document data management device in accordance with the exemplary embodiment of the present invention is described.

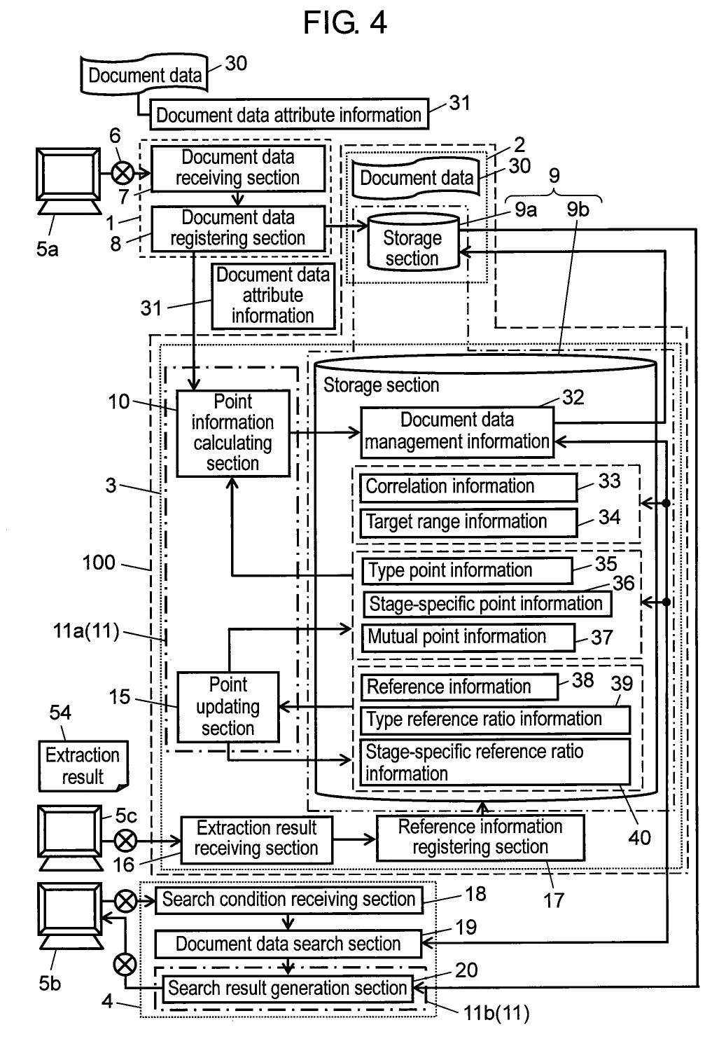

FIG. 4 is a function block diagram to illustrate development document data management device 100 in accordance with one exemplary embodiment of the present invention.

Document data registering device 1 includes document data receiving section 7 and document data registering section 8. Document data storing device 2 includes storage section 9a storing document data 30 received from document data registering section 8.

Firstly, document data receiving section 7 receives document data 30 and document data attribute information 31 transmitted from user terminal 5a via communication line 6.

Next, document data registering section 8 transmits document data 30 received by document data receiving section 7 to document data storing device 2, and transmits document data attribute information 31 to document data management information storing device 3.

Document data management information storing device 3 includes storage section 9b, point information calculating section 10, point updating section 15, extraction result receiving section 16, and reference information registering section 17.

These sections constituting document data management information storing device 3 are described.

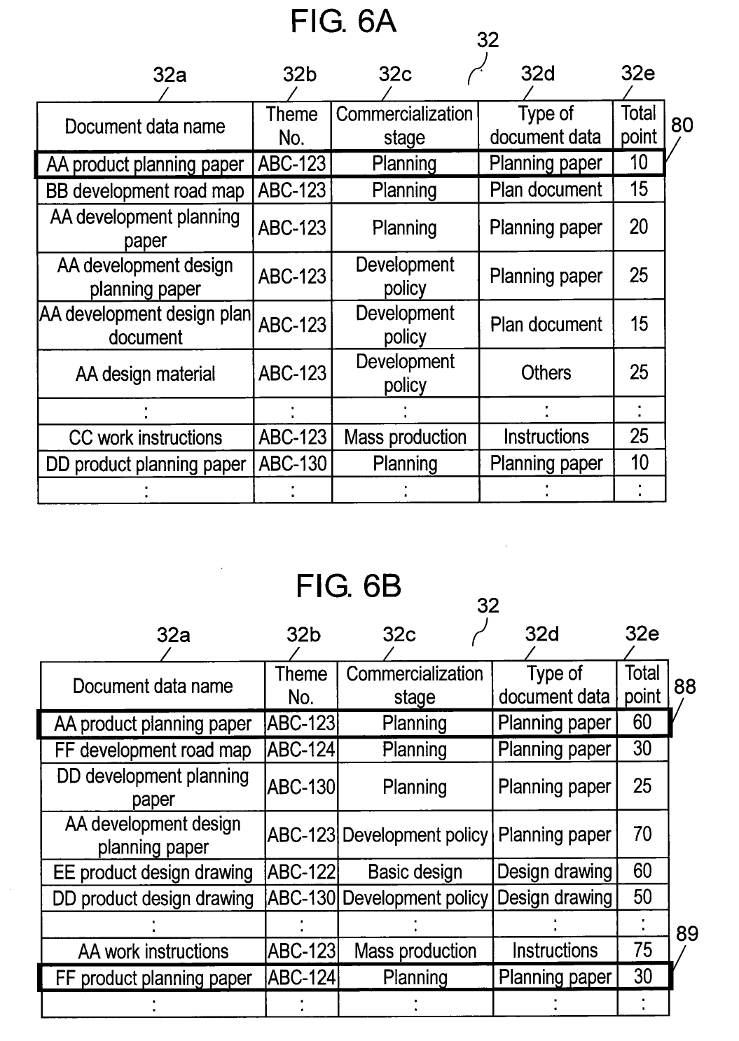

Firstly, point information calculating section 10 included in control section 11a calculates a total point (see 32e in FIG. 6A) given to document data 30 stored in storage section 9a based on document data attribute information 31 received from document data registering section 8 and each point information 35, 36, and 37 stored in storage section 9b. Each point information 35, 36 and 37 is described later.

Next, contents stored in storage section 9b are described.

Firstly, storage section 9b stores information (hereinafter, referred to as document data management information 32) in which a total point (see 32e in FIG. 6A) calculated by point information calculating section 10 is added to document data attribute information 31 transmitted from document data registering section 8 to point information calculating section 10.

The content stored as document data management information 32 is described later with reference to FIG. 6A.

Next, storage section 9b stores correlation information 33 and target range information 34.

Correlation information 33 associates the correlation of each product with a product number and a development theme of each product.

Furthermore, target range information 34 sets a range of products to be searched, that is, sets the number of stages apart in the correlation of products to be searched when document data 30 are searched.

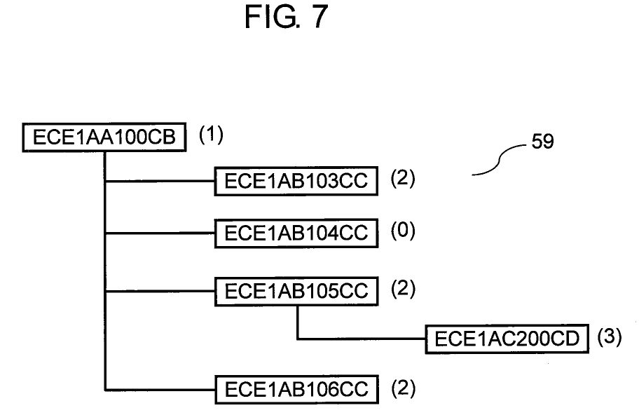

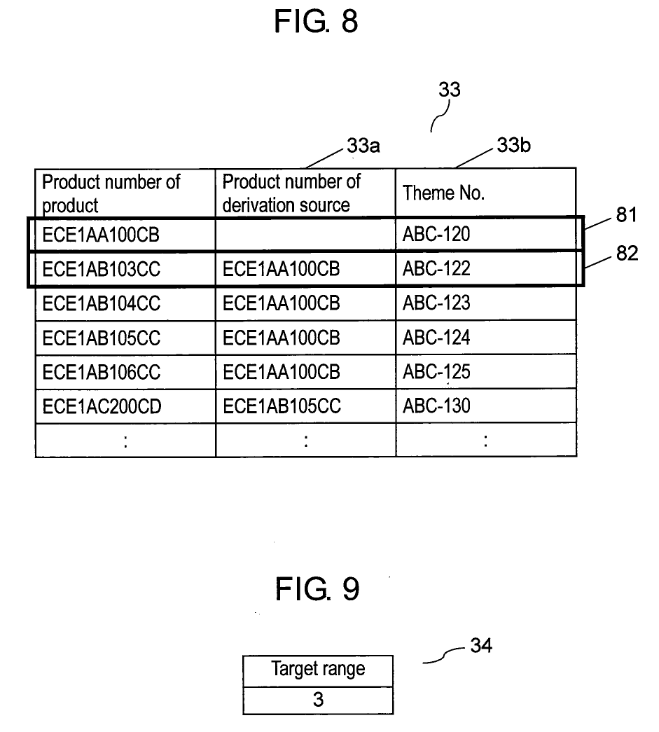

As an example of such information, FIG. 7 shows correlation 59 of products, FIG. 8 shows correlation information 33 based on correlation 59 of products shown in FIG. 7, and FIG. 9 shows target range information 34 indicating the search range. The details thereof are described later.

Next, storage section 9b stores point information 35, 36, and 37 as points given to document data 30.

Specifically, type point information 35 set for each type of document data 30, stage-specific point information 36 set for each stage of development, and mutual point information 37 based on the correlation are stored.

Point information 35, 36, and 37 may be stored at any time, but preferably stored before document data attribute information 31 is input.

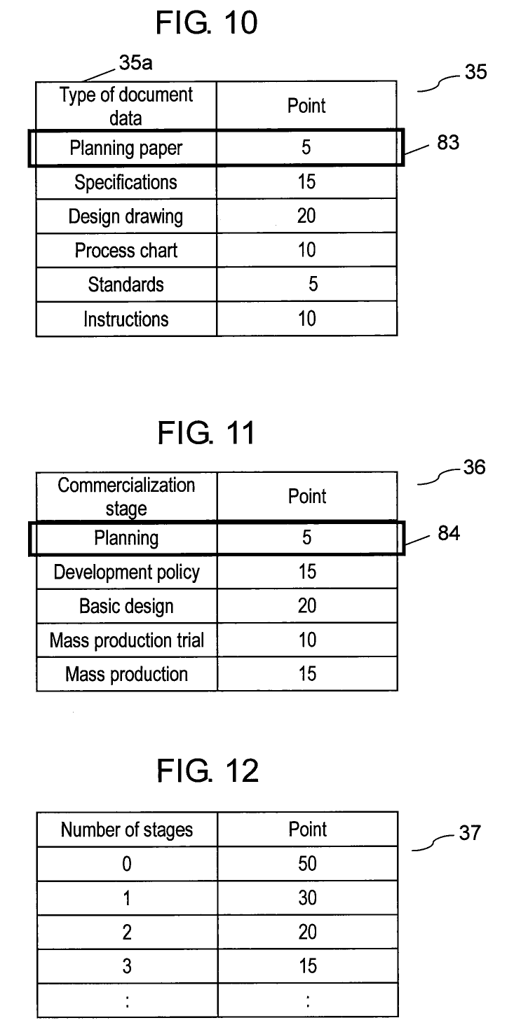

FIG. 10 shows an example of the contents to be stored as type point information 35, FIG. 11 shows an example of the contents to be stored as stage-specific point information 36, and FIG. 12 shows an example of the contents to be stored as mutual point information 37. The details of such information are described later.

Next, storage section 9b stores reference information 38, type reference ratio information 39 and stage-specific reference ratio information 40.

Reference information 38 is an accumulation of information on document data 30 effectively used in specifying a cause of a defect, that is, accumulation of extraction results 54.

Type reference ratio information 39 is obtained by calculating the ratio of the number of references of each type of document data 30 referred to so far with respect to the number of references of all reference information 38.

Similarly, stage-specific reference ratio information 40 is obtained by calculating the ratio of the number of references of each commercialization stage referred to so far with respect to the number of references of all reference information 38.

These ratios of the number of references are updated via below-mentioned point updating section 15 every time new extraction result 54 is accumulated at any time.

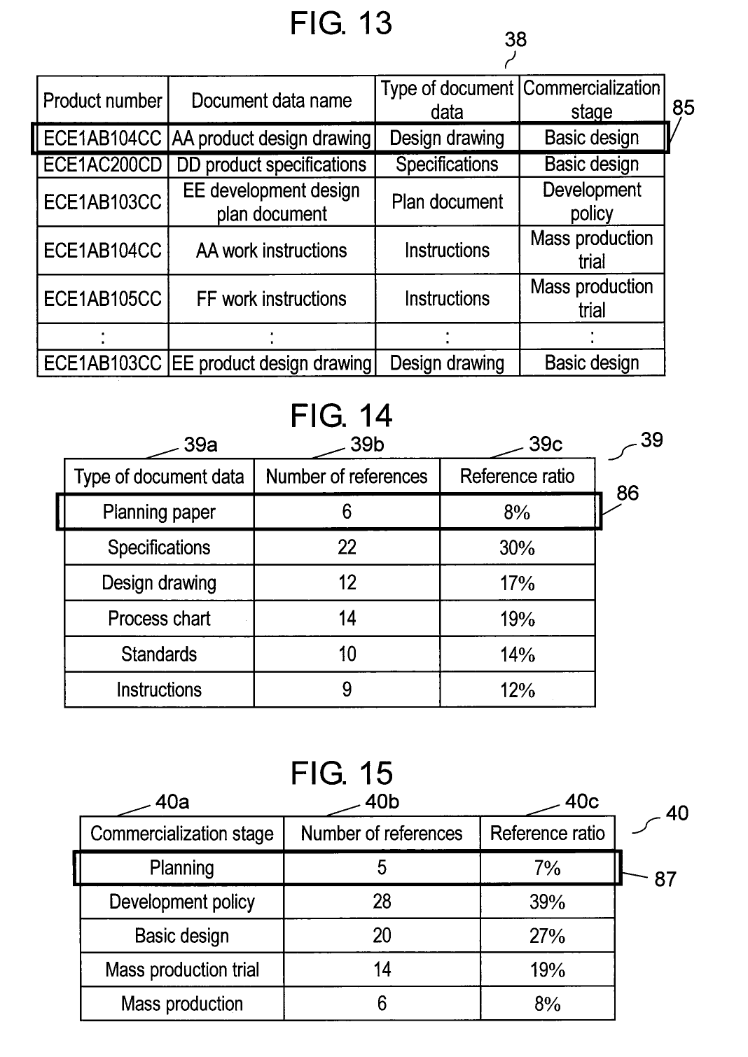

FIG. 13 shows contents to be stored as reference information 38; FIG. 14 shows contents to be stored as type reference ratio information 39; and FIG. 15 shows contents to be stored as stage-specific reference ratio information 40. The details thereof are described later.

Next, point updating section 15 included in control section 11a is described.

Point updating section 15 is provided so as to reflect results of search by using development document data management device 100 in accordance with one exemplary embodiment of the present invention on the next time searching or later.

Firstly, extraction result 54 used for specifying a cause of a defect is transmitted from user terminal 5c to the below-mentioned extraction result receiving section 16 via communication line 6, and then transmitted to storage section 9b via the below-mentioned reference information registering section 17.

Transmitted extraction results 54 are accumulated as reference information 38, and used for updating type reference ratio information 39 and stage-specific reference ratio information 40 via point updating section 15 at any time.

Furthermore, point updating section 15 updates type point information 35 and stage-specific point information 36 stored in storage section 9b based on the updated type reference ratio information 39 and stage-specific reference ratio information 40. The details thereof are described later.

Furthermore, document data searching device 4 includes search condition receiving section 18, document data search section 19, and search result generation section 20.

Search condition receiving section 18 receives a condition for searching document data 30 transmitted from user terminal 5b.

Document data search section 19 searches document data 30 matching the search condition received by search condition receiving section 18 from document data management information 32 as calculation results of information 35, 36 and 37.

Search result generation section 20 included in control section 11b generates information of document data 30 searched by document data search section 19 as a list and transmits it to user terminal 5b.

In the above description, as a peripheral device of development document data management device 100 having document data storing device 2 and document data management information storing device 3, a configuration in which document data registering device 1 and document data searching device 4 and others are installed is described.

However, the present invention is not limited to the above-mentioned configuration, and it may be an integrated type device as long as each section satisfies the function to be required.

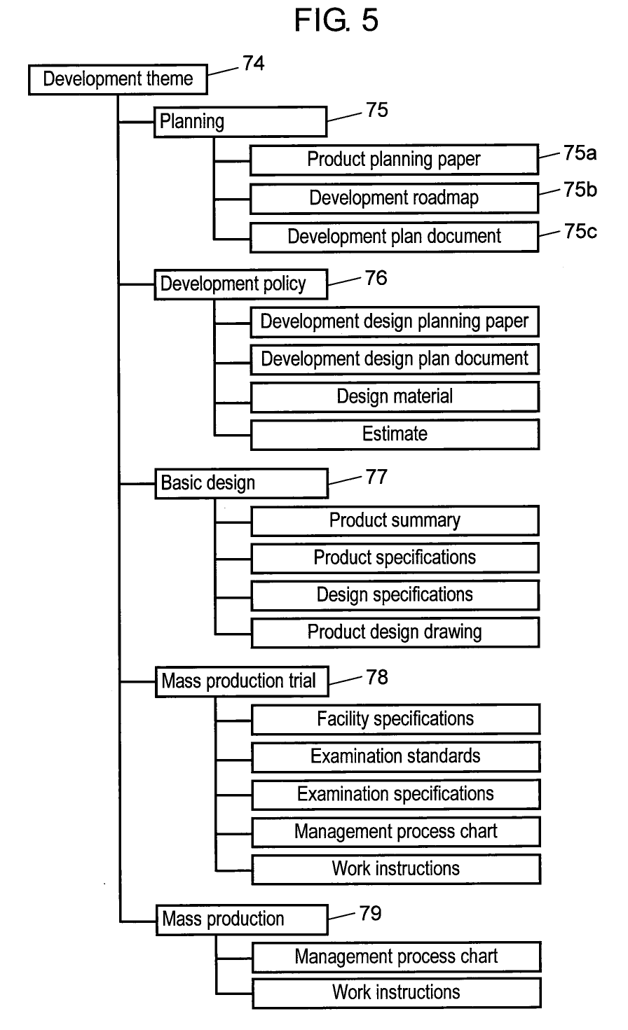

Next, with reference to FIGS. 5 to 15, information of one example of the exemplary embodiment of the present invention is described.

FIG. 5 is a hierarchy view showing the relation between commercialization stages for developing a product and types of document data formed in each commercialization stage in document data 30 managed by development document data management device 100 and development document data management system 101 in accordance with the exemplary embodiment of the present invention.

That is to say, when a product is developed, development theme 74 for mass producing the products is set.

An example shown in FIG. 5 shows that development theme 74 reaches mass production through five commercialization stages including planning 75, development policy 76, basic design 77, mass production trial 78, and mass production 79.

Furthermore, it is shown that in planning 75 as the first commercialization stage, three documents: product planning paper 75a, development roadmap 75b, and development plan document 75c are formed.

When a plurality of development themes 74 are present, different theme numbers (Nos.) are given to each development theme 74 so that they can be distinguished from each other.

FIG. 6A shows an example of a data configuration of document data management information 32 to be stored in storage section 9b in FIG. 4A.

As shown in FIG. 6A, document data management information 32 is associated with the following information for each document data 30 shown as an example in “document data name” column 32a.

Firstly, “theme number (No.)” column 32b indicates which development theme each of document data 30 is related to.

Next, “commercialization stage” column 32c indicates which stage in the commercialization stages document data 30 is formed in the above-mentioned theme No.

Furthermore, “type of document data” column 32d shows classification of document data 30 formed in each commercialization stage including a design drawing, a plan document, instructions, and the like.

These classifications are appropriately made based on the described matters including the contents, mode, or the like, of each document data 30.

Note here that the above-mentioned contents are input as document data attribute information 31 together with document data 30.

By the way, in “total point” column 32e, the contents calculated by point information calculating section 10 in FIG. 4 are described, and “total of points” given to each of document data 30 are shown.

Herein, the total point in this exemplary embodiment shows the degree of matching with a search condition requested by a user when document data 30 are searched. Therefore, this total point needs to be set so that it corresponds to the aim of search.

In this exemplary embodiment, the aim of search is intended to specify a cause of a defect.

In the following description, the provided points are set based on experiences of the present inventors, values suitable for the commercialization stages and the types of the document data are set according to the frequency at which each of document data 30 are referred to.

Therefore, the total of the points shows the height of expectations to correspond to the aim of search. As the value shown in “total point” column 32e is higher, the possibility of fulfilling a user's request becomes higher.

In this exemplary embodiment, in document data management information 32, the above-mentioned theme No., commercialization stage, type of document data, and total point are stored as one record 80 such that they are associated with document data 30 shown in “document data name” column 32a.

Specifically, “AA product planning paper” as document data (first document data) 30 of “AA product” as the first product shown in the first row of FIG. 6A shows that the development theme is related to “ABC-123 product.”

Then, “AA product planning paper” is document data formed as document data attribute information (first document data attribute information) 31 in a “planning” stage in the commercialization stage. It is shown that the “type of document data” is “planning paper.”

In other words, as the point given to each item, with respect to “AA product planning paper,” “5” points are given to “planning” stage in the commercialization stage (see, FIGS. 11), and “5” points are given to “planning paper” as the type of document data (see FIG. 10). Therefore, document data management information (first document data management information) 32 is obtained by giving 10 points as the total point to document data attribute information (first document data attribute information) 31. Note here that the detail of each point is described later.

Next, an example in which a second product is derived from the first product as a base product is described.

Correlation 59 of products shown in FIG. 7 describes a basic product whose product number is “ECE1AA100CB” and products related to this product, so-called products having a “correlation” to the product.

In other words, products are developed such that a product whose product number “ECE1AA100CB” is developed as a basic product, that is, a “parent” product, and products having the following four product numbers are developed as derivative products, that is, “child” products.

That is to say, the product numbers of the “child” products are “ECE1AB103CC,” “ECE1AB104CC,” “ECE1AB105CC,” and “ECE1AB106CC.”

Furthermore, one of the “child” products, which has a product number “ECE1AB105CC,” has a further derivative product.

That is to say, a product having a product number “ECE1AC200CD” is a product derived from the product having the product number “ECE1AB105CC” and corresponds to a “grandchild” of the product having the product number “ECE1AA100CB.”

By the way, at the right side of each of these product numbers, a number expressed by (n) is written.

This shows a “number of stages” that represents a correlation between the product numbers. In this exemplary embodiment, when the product number “ECE1AB104CC” is noted, this number indicates the correlation between this product and a product having each product number, that is, how many stages are present between this product and a product having each product number.

FIG. 8 shows a data configuration of correlation information 33 stored in storage section 9b in FIG. 4.

As shown in FIG. 8, correlation information 33 stores, as one record, a “product number” of a target product, a product number of a product from which the target product is derived (hereinafter, referred to as a “product number of derivation source”) and a theme No. given when each product is developed.

Note here that FIG. 8 shows correlation 59 of products related to product number “ECE1AA100CB” shown in FIG. 7 as correlation information 33.

Firstly, record 81 in the first row is related to the product number “ECE1AA100CB.”

This “ECE1AA100CB” is a product number of a basic product, and a product of the derivation source as a parent product is not present. Therefore, the “product number of derivation source” column 33a is blank.

Then, “ABC-120” as the theme No. that is given when “ECE1AA100CB” is developed is shown in “theme No.” column 33b.

Next, record 82 in the second row is related to a product having a product number “ECE1AB103CC,” that is, a product derived from the above-mentioned “ECE1AA100CB.”

From the description as to FIG. 8, it is shown that a product number of the derivation source as a parent of “ECE1AB103CC” is “ECE1AA100CB.”

Also, it is shown that the theme No. when “ECE1AB103CC” is developed is “ABC-120.”

By using such correlation information 33, when a product number is noted as the first product, it is possible to specify a correlation between the product number of the second product as the target and the product number of the noted first product, that is, how many stages are present therebetween.

Furthermore, when correlation information 33 in FIG. 8 and document data management information 32 in FIGS. 6A and 6B are used, a product to which document data 30 is related can be also specified via theme No.

FIG. 9 shows an example of target range information 34 that is a target range when search is executed.

Specifically, target range information 34 sets a range of product numbers to be searched, that is, sets the number of stages apart from the noted product number in the correlation of products to be searched when document data 30 are searched.

In the example shown in FIG. 9, it is shown that the product numbers three stages apart from the noted product number are included in the search range.

Herein, a specific example is described with reference to correlation 59 shown in FIG. 7.

In FIG. 7, when the product number “ECE1AB104CC” is noted, the number of stages between the product number “ECE1AB104CC” and each product number is shown in the right side of each product number.

That is to say, target range information 34 shown in FIG. 9 allows the product numbers within three stages to be a search target, and all of the correlations of the products shown in FIG. 7 are included within three stages when the product number “ECE1AB104CC” is noted. Therefore, all of the listed product numbers are included in the search target.

In the correlation of FIG. 7, if a product number derived from the product number “ECE1AB200CD” is further present, the number of stages of such a product number is 4. Accordingly, such a product number is out of the search target.

FIG. 10 shows an example of a data configuration of type point information 35 stored in storage section 9b in FIG. 4.

The contents show that points are set with respect to respective items shown in “type of document data” column 35a, respectively. Specifically, record 83 in the first row shows that when the type of the document data is a “planning paper,” the points added to the corresponding document data 30 are “5” points.

Note here that a point related to the type of the document data set in this exemplary embodiment is set so that it can be extracted more easily as document data 30 corresponding to the aim as document data 30 is referred to more frequently when a cause of a defect is specified. Specifically, when a cause of a defect is specified, since a “design drawing” is frequently referred to, points are set so that the highest point is given to the “design drawing.”

FIG. 11 shows an example of a data configuration of stage-specific point information 36 stored in storage section 9b in FIG. 4.

The contents show that points are set corresponding to each of the commercialization stages in the development of a product from “planning” to “mass production.” Specifically, record 84 in the first row shows that when the commercialization stage is “planning,” the points added to the corresponding document data 30 are “5” points.

Note here that points related to stage-specific point information 36 set in this exemplary embodiment are set so that document data 30, which are referred to more frequently, can be extracted more easily as document data 30 corresponding to the aim when a cause of a defect is specified. Specifically, since document data 30 formed in the stage of “basic design” is referred to frequently when a cause of a defect is specified, points are set so that the highest point is given to the “basic design.”

FIG. 12 shows an example of a data configuration of mutual point information 37 stored in storage section 9b in FIG. 4.

The contents show that points are set with respect to products having correlation 59 shown in FIG. 7 according to the number of stages from the noted product number. Specifically, as the product number is nearer to the stage of the noted product number, document data 30 is likely to satisfy the aim. Therefore, in this exemplary embodiment, points are set so that a higher point is given to the product whose number of stages is small.

In an example of FIG. 12, it is shown that “50” points are added to the product whose number of stages is “0,” that is, document data 30 related to the noted product number itself.

Then, it is shown that document data 30 related to the product number that is one stage apart from the noted product number, that is, document data 30 related to the product number having a direct correlation to the noted product number, “30” points are added.

FIG. 6B shows the specific example of the above-mentioned contents. Record 88 in the first row of FIG. 6B shows a product number “AA product (ECE1AB104CC)” as a first product, and record 89 in the ninth row shows a product number “FF product (ECE1AB105CC)” as a second product.

That is to say, it is shown from the document data attribute information (second document data attribute information) 31 that a document data name of “FF product planning paper” in record 89 is a “planning paper” formed in a “planning” commercialization stage. In other words, “5” points as the stage-specific point and “5” points as the type points are given.

Furthermore, from the description as to FIG. 7, the number of stages of the product number “ECE1A104CC” and the product number “ECE1AB105CC” are “2,” and “20” points is given as a mutual point.

Therefore, the total points given to document data management information (second document data management information) 32 of the “FF product planning paper” are “30” points.

Thus, when the first product and the second product having correlation 59 are present, mutual point information 37 is added and the second document data management information is formed.

FIG. 13 shows an example of a data configuration of reference information 38 stored in storage section 9b in FIG. 4.

The configuration contents include, as one record, a product number of a product with a defect, a “document data name” that is effective for specifying a cause of the defect, a “type of document data” by which document data 30 are classified, and a “commercialization stage” in which document data 30 are located. Specifically, record 85 in the first row in FIG. 13 shows the results when a defect occurs in the product number “ECE1AB104CC.”

In other words, when a cause of a defect occurring in the product number “ECE1AB104CC” is specified, effectively used document data 30 is an “AA product design drawing.”

The “AA product design drawing” is document data formed in a “basic design” stage in the commercialization stage, and is classified as a “design drawing” in the types of the document data.

In FIG. 13, for easy understanding of reference information 38, the “type of document data” and the “commercialization stage” are also described. However, these items can be omitted from reference information 38 because these items can be associated with the “document data name” in document data management information 32 shown in FIG. 6A.

FIG. 14 shows an example of a data configuration of type reference ratio information 39 stored in storage section 9b in FIG. 4.

In type reference ratio information 39, when a cause of a defect is specified, the number of cases in which each of document data 30 shown in “type of document data” column 39a is effective is shown in “number of references” 39b. Furthermore, the ratio of each of the number of references to all the number of references is shown in “reference ratio” column 39c.

Specifically, in FIG. 14, record 86 in the first row shows that in order to specify a cause of a defect, the number of references to the “planning paper” is “6.” Then, it is shown that the ratio of the number of references of “6” to the total number of references is “8%”.

Note here that when type point information 35 shown in FIG. 10 is updated based on the thus obtained type reference ratio information 39, the search accuracy can be improved.

FIG. 15 shows an example of a data configuration of stage-specific reference ratio information 40 stored in storage section 9b in FIG. 4.

In stage-specific reference ratio information 40, when a cause of a defect is specified, the number of cases, in which each of document data 30 formed in each stage in “commercialization stage” column 40a is effective, is shown in “number of references” 40b. Furthermore, the ratio of each of the number of references to all the number of references is shown in “reference ratio” column 40c.

Specifically, in FIG. 15, record 87 in the first row shows that in order to specify a cause of a defect, the number of references to the document data formed in the “planning” stage is “5.” Then, it is shown that the number of references of “5” corresponds to the total reference number of references of “7%.”

Note here that when stage-specific point information 36 shown in FIG. 11 is updated based on the thus obtained stage-specific reference ratio information 40, the search accuracy can be improved. Hereinafter, an operation of development document data management device 100 and development document data management system 101, which are configured as mentioned above, in accordance with the exemplary embodiment of the present invention is described.

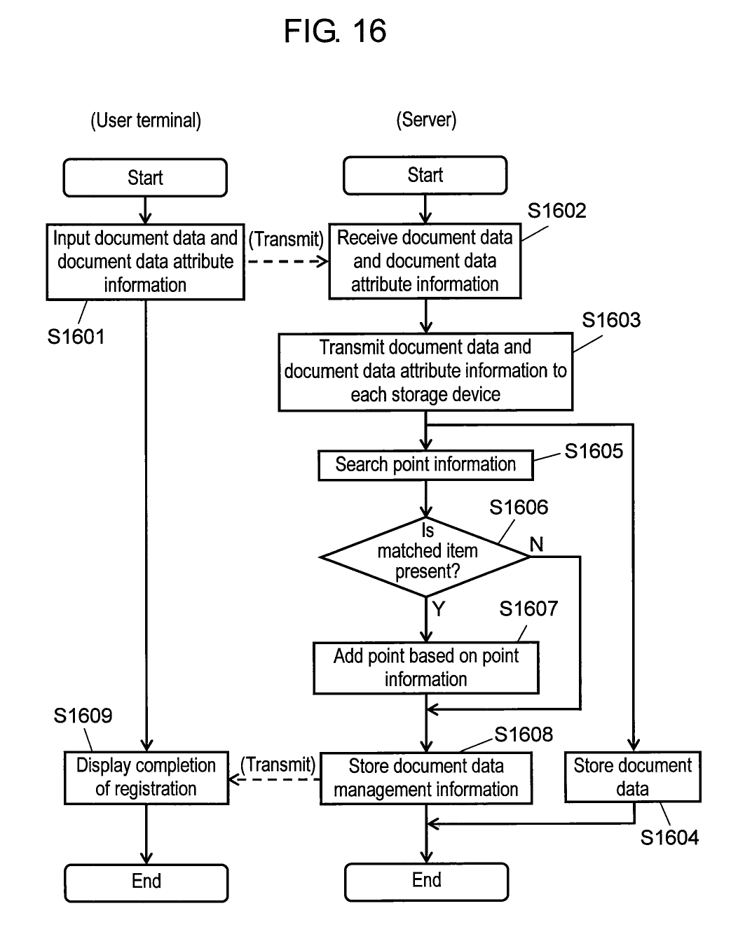

Firstly, with reference to the flowchart shown in FIG. 16, an operation in which document data 30 and document data attribute information 31 register document data management information 32 is described.

Firstly, a user connects user terminal 5a to document data registering device 1 via communication line 6, and transmits document data 30 and document data attribute information 31 to document data registering device 1 (S1601).

Next, in document data registering device 1, when document data receiving section 7 receives document data 30 and document data attribute information 31 (S1602), document data registering section 8 transmits document data 30 to document data storing device 2, and transmits document data attribute information 31 to document data management information storing device 3 (S1603).

Document data 30 transmitted to document data storing device 2 are stored in storage section 9a (S1604).

On the other hand, document data attribute information 31 transmitted to document data management information storing device 3 is transmitted to point information calculating section 10.

At this time, point information calculating section 10 included in control section 11a refers to type point information 35 and stage-specific point information 36 stored in storage section 9b, and searches whether or not items matching one or both of the “type of document data” and the “commercialization stage” included in the received document data attribute information 31 (S1605).

As a search result in point information calculating section 10, when an item matching one or both of the “type of document data” and the “commercialization stage” is present (Y in S1606), point information calculating section 10 adds a point corresponding to the matched item (S1607).

As a specific example, a formation process of record 80 in the first row of document data management information 32 shown in FIG. 6A is described.

Firstly, an “AA product planning paper” that is “planning paper” formed in a “planning” stage is transmitted to point information calculating section 10.

At this time, in the step shown in S1605, searching is carried out whether or not an item matching one or both of the “type of document data” and the “commercialization stage” is present.

As a result, when the “planning paper” in type point information 35 and the “planning” of stage-specific point information 36 are the matched items (Y in S1606), the step proceeds to S1607. Then, “5” points set to “planning paper” are added as shown in type point information 35, and “5” points set to the “planning” are added as shown in stage-specific point information 36, so that “10” points as the total point are added to the document data name “AA product planning paper.”

The thus formed record is stored in storage section 9b as document data management information 32 (S1608).

When an item matching type point information 35 and stage-specific point information 36 is not present (N in S1606), document data management information 32 to which no points are added is formed.

In this way, from document data attribute information 31 representing the positioning of document data 30, document data management information 32 to be used in searching document data 30 is formed and stored in storage section 9b.

When the registration of document data 30 is completed, a screen showing that the registration is completed is displayed in user terminal 5 (S1609).

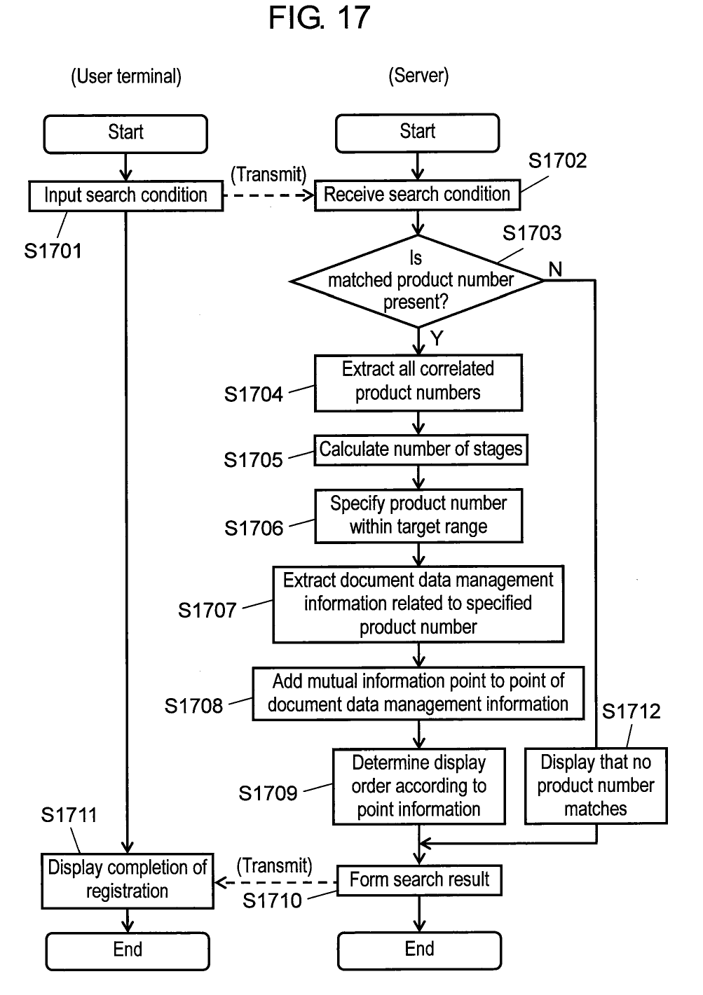

Next, with reference to the flowchart shown in FIG. 17, processing for searching document data 30 is described.

Firstly, a user connects user terminal 5b to document data searching device 4 via communication line 6.

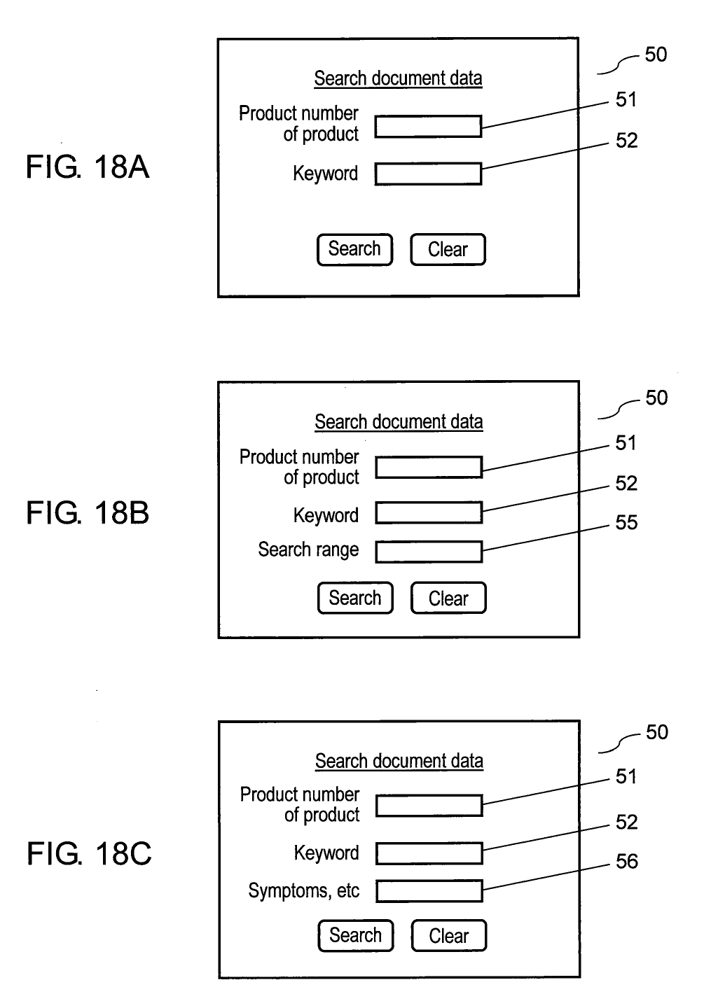

At this time, on user terminal 5b, document data searching screen 50 shown in FIG. 18A is displayed. To this document data search screen 50, a search condition is input (S1701).

Herein, a product number of a product with a defect, for example, is input in first input part 51 to which a “product number of product” is input.

To second input part 52 to which a “keyword” is input, some characters or values need not always be input. If a character string effective for searching document data 30 exists, it may be input.

When search condition receiving section 18 receives the search condition (S1702), in document data searching device 4, the following processing is carried out.

Firstly, document data search section 19 searches correlation information 33 stored in storage section 9b based on this search condition and searches whether or not a product number matching the product number input in this search condition is present.

As a result of search, when a product number matching the search condition is present (Y in S1703), all the correlated product numbers are extracted with reference to correlation information 33 (S1704).

At this time, the number of stages between the product number input into the search condition and each product in correlation thereto are also calculated (S1705).

Then, based on the previously set target range information 34, a product number having the number of stages that are not more than the value set in target range information 34 is set as the search target from the extracted product numbers having a correlation (S1706).

Note here that as target range information 34 for specifying the search target, a previously set value may be used as mentioned above. As shown in FIG. 18B, a user may input the number of stages appropriately as a predetermined search range 55. In this way, it is possible to change the number of stages so as to expand or shrink the search range with reference to the search results.

Next, from correlation information 33 shown in FIG. 8, a theme No., to which a product number specified in S1706 belongs, is specified, and document data management information 32 including this theme No. is extracted (S1707).

Furthermore, with respect to the points given to the extracted document data management information 32, points based on mutual point information 37 are added (S1708).

In document data management information 32 obtained by the above-mentioned processing, it is judged that when record 80 has higher total points of the given points of record 80, the possibility that the search condition indicated by a user is satisfied becomes higher.

Therefore, document data management information 32 is aligned in the order from the higher total point, that is, the higher total of points applied to each record (S1709).

Then, in search result generation section 20 included in control section 11b, a search result in which the total points are aligned in the descending order is formed (S1710).

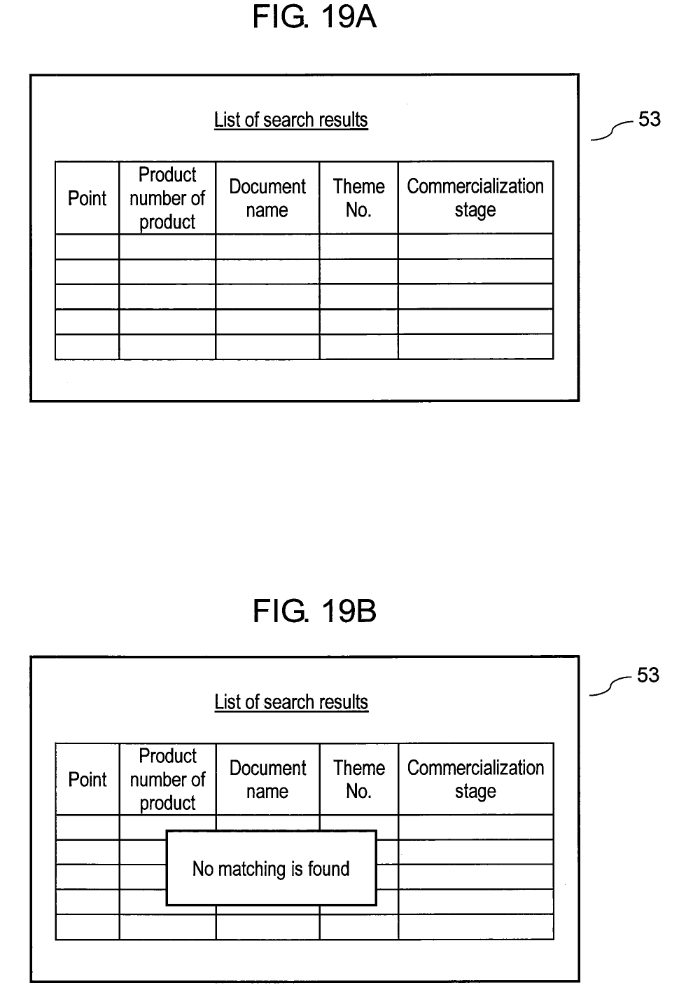

The results are displayed to user terminal 5b as search result screen 53 as shown in FIG. 19A (S1711).

On the other hand, in S1703, when a product number matching the search condition is not present (N in S1703), “no matching is found” is displayed on search result screen 53 as shown in FIG. 19B (S1712).

Note here that when searching is carried out without using correlation information 33, firstly, a product number corresponding to the search condition is searched from document data management information 32 in S1703.

Then, the search result is Y in S1703, the step may proceed to S1707 without carrying out the contents from S1704 to S1706.

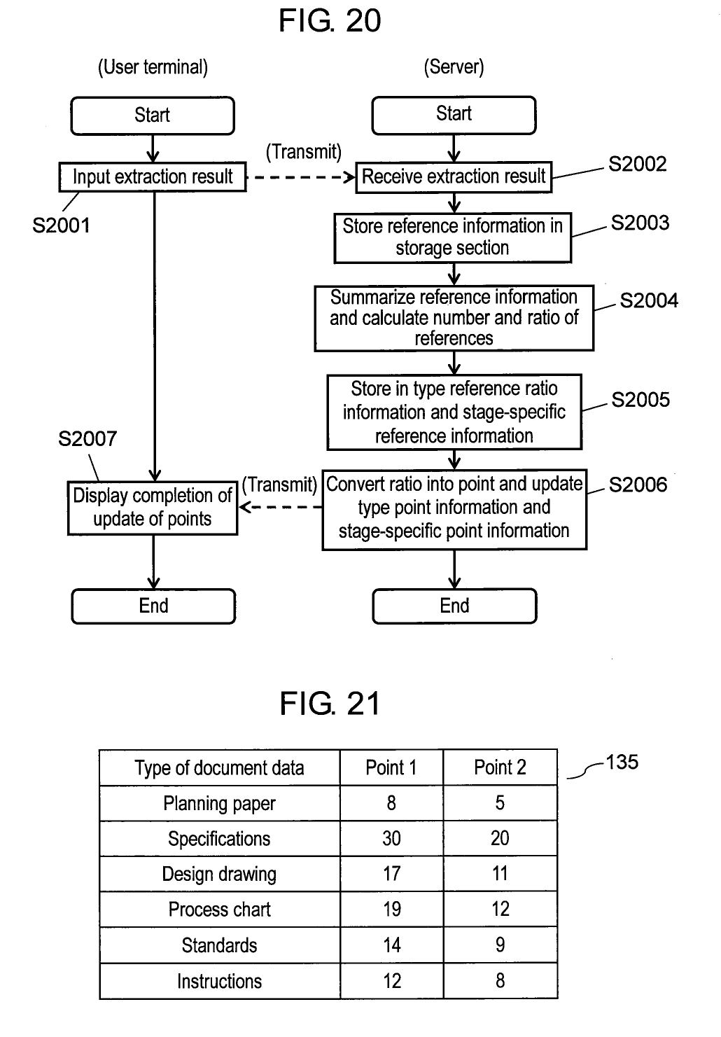

Next, with reference to the flowcharts shown in FIGS. 4 and 20, a mechanism for improving the search accuracy by reflecting the search result is described.

Firstly, from the search result described with reference to FIGS. 17 and 19A, document data 30 employed by a user is extracted.

What the user judged to be useful is made to be extracted result 54, and as shown in FIG. 4, it is transmitted from user terminal 5c to extraction result receiving section 16 via communication line 6 (S2001 and S2002).

Then, extraction result 54 received by extraction result receiving section 16 is stored in storage section 9b as reference information 38 via reference information registering section 17 (S2003).

At this time, point updating section 15 included in control section 11a generates new reference information 38 by using all reference information 38 stored in storage section 9b and extraction result 54 that is newly provided at this time.

That is to say, firstly, as a result that extraction result 54 as a base of new reference information 38 is added, the ratio of each item to the total number is summarized again for the type of document data and for each of the ratio of the commercialization stage (S2004), and the ratios are stored in type reference ratio information 39 and stage-specific reference information 40, respectively (S2005).

Then, each of the updated reference ratio information 39 and 40 is converted into points so as to update type point information 39a and stage-specific point information 40a (S2006).

Finally, the completion of update of type point information 39a and stage-specific point information 40a is transmitted to user terminal 5c and the completion is displayed on user terminal 5c (S2007).

The above-mentioned operation is carried out by a program executed by a computer, and the program can be achieved by storing it in a special purpose computer or a general purpose computer.

Note here that a method of converting each of updated reference ratio information 39 and 40 into each point is carried out by treating the obtained ratio as the absolute value of the point or by multiplying the obtained ratio by the predetermined value.

The specific examples thereof are described with reference to FIGS. 10, 11, 14, 15, 21 and 22.

Firstly, FIGS. 10 and 11 show type point information 35 and stage-specific point information 36 as mentioned above. Points given to each of these point information 35 and 36 are values prepared as an initial value of development document data management system 101 shown in this exemplary embodiment.

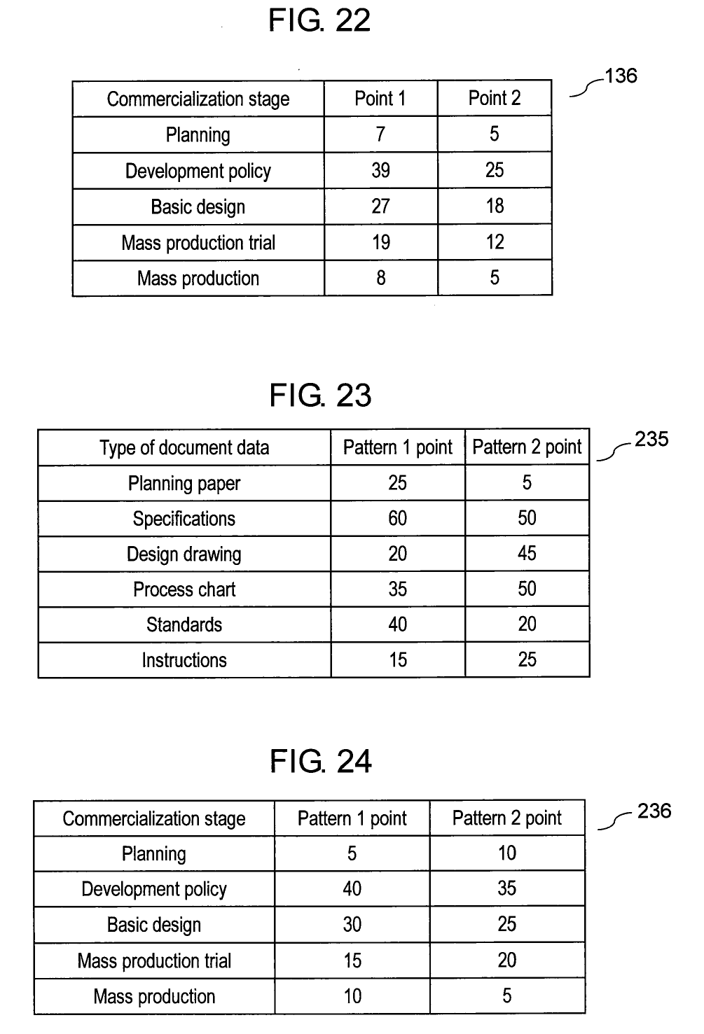

Then, as a result of operating development document data management system 101, search results shown in FIGS. 14 and 15 are obtained. Based on the search results, results reflecting the reference ratios on the points are “point 1” and “point 2” of type point information 135 and stage-specific point information 136 shown in FIGS. 21 and 22.

That is to say, “point 1” is obtained by directly updating the calculated “reference ratio” as a new type point or a new stage-specific point.

On the other hand, “point 2” is obtained by making the total value of points a certain value, and updating it as a type point or a stage-specific point according to the calculated “reference ratio.”

In addition to the above, various methods of converting the reference ratio are present. However, by reflecting the search result employed by a user on the point as a search index, the search accuracy can be improved.

Note here that the registration of extraction result 54 may be carried out one by one by each user at any time by using user terminal 5c, or may be carried out by a certain person who collects information from each user via a medium such as paper by using user terminal 5c.

Furthermore, each point may be updated regularly in a predetermined time, for example, once a month, or may be updated every time extraction result 54 is registered.

As is apparent from the above description, according to this exemplary embodiment in, for example, measures to defects, by providing points according to the positioning of each document data 30 to various document data 30 formed at the time when a product is developed, the following effects can be obtained.

Firstly, even when the contents of document data 30 are materials such as drawings and tables, a unified index such as a point is set according to the described contents, unitary search can be carried out. In particular, it is possible to prevent problems such as incomplete search of drawings and tables, which have occurred in the case of a conventional keyword search.

Moreover, since an objective index like a number is used, incomplete search due to small difference in expression that occurred in a keyword search in which matched words or similar words are extracted by using a keyword, can be prevented. It is possible to extract the intended document data 30 exactly.

Furthermore, when correlation information 33 showing the relation between products is used, highly relevant searching concentrated into objects having high correlation can be carried out by narrowing the search range as compared with a search targeting all document data 30.

Note here that the above description employs contents for the aim of improving the search accuracy. However, according to the amount of accumulated document data 30 or the using the aim thereof, the “point” as the search index may not be updated but may be fixed to a predetermined value.

In this way, development document data management device 100 may not be provided with extraction result receiving section 16, reference information registering section 17 and point updating section 15 for updating reference information 38. Thus, a configuration of hardware can be simplified.

### Second Exemplary Embodiment

Next, a second exemplary embodiment describes measures against cases in which products are the same but extracted document data are specific for each cause of a defect.

For example, for specifying one cause of a defect, a “design drawing” in a “basic design” stage may be referred to in many cases. For specifying another cause of a defect, “instructions” in a “mass production” stage may be referred to in many cases.

When these are analyzed, defects can be classified in, for example, “defect related to a new function that is newly mounted on the target product” and “defect related to the function that has been used conventionally,” or “defect in a mechanical system” and “defect in an electric system,” or “defect caused by hardware” and “defect caused by software,” and the like.

In addition, defects can be classified for each specific symptom, for example, “short-circuit of circuit,” “deterioration of driving section,” “external influence such as thunder,” and the like.

In such a case, document data search screen 50 shown in FIG. 18C may be used. That is to say, as mentioned above, for specifying a cause of a defect, third input part 56 for inputting classification items showing the tendency peculiar to extracted document data 30 is provided.

In particular, when an input form to third input part 56 uses a pull-down menu for designating selectable items, searchable symptoms are displayed, thereby allowing a user to extract an appropriate option easily.

In this way, when a product number of a product and a symptom of a defect are designated, document data 30 can be searched more accurately.

Furthermore, when such plurality of symptoms of defects is present, points may be set according to the symptoms of defects. Hereinafter, the procedure thereof is described.

Firstly, based on the conventional tendency or performance, type point information 235 and stage-specific point information 236 are set. Examples are shown in FIGS. 23 and 24.

An example of the “pattern 1 point” may include what often referring to “specification” formed in the “development policy” stage, such as a “new function that is newly mounted on the target product.”

Then, to each item of type point information 235 and stage-specific point information 236 of the “pattern 1 point,” points are appropriately set based on the conventional tendency or performance.

Similarly, an example of the “pattern 2 point” may include what often referring to both “specification” and “process chart” formed in the “development policy” stage, such as a “function that has been used conventionally”.

Then, to each item of type point information 235 and stage-specific point information 236 of the “pattern 2 point,” points are appropriately set based on the conventional tendency or performance.

Firstly, by using the content shown in FIGS. 23 and 24 as an initial value, development document data management system 101 shown in FIG. 1 is operated.

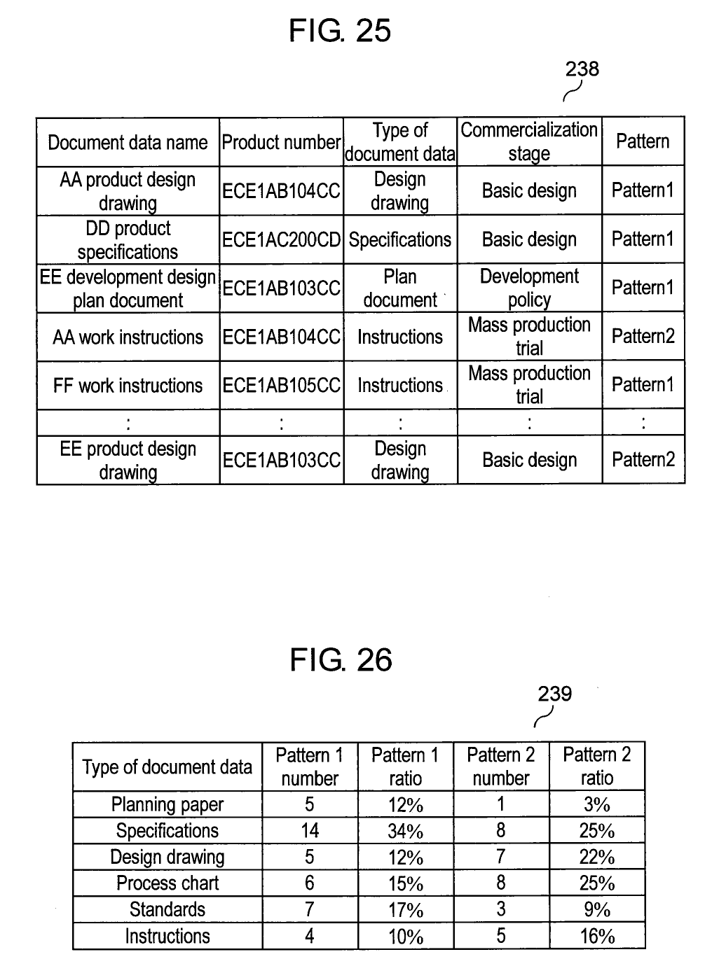

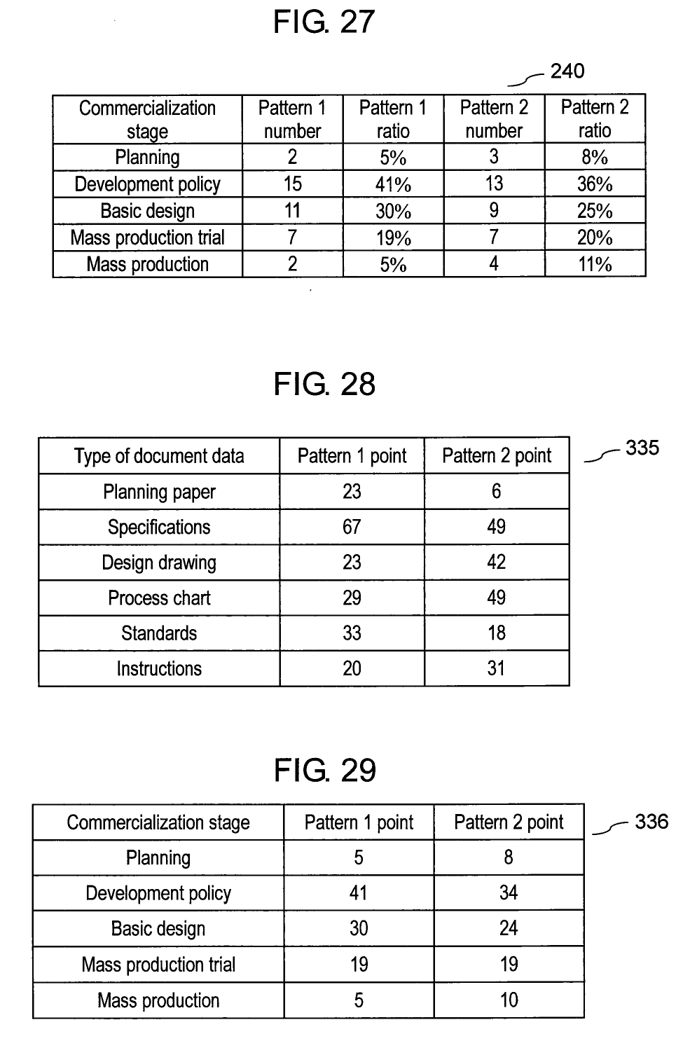

Thereafter, a large number of users search document data 30 by using development document data management system 101. As a result, reference information 238 shown in FIG. 25 is obtained. Reference frequencies of document data 30 are calculated from reference information 238 and the calculated results are summarized as type reference ratio information 239 and stage-specific reference ratio information 240 as shown in FIGS. 26 and 27. FIG. 26 and FIG. 27 show the contents of information 239 and information 240.

Type point information 335 and stage-specific point information 336 are updated based on the thus obtained type reference ratio information 239 and stage-specific reference ratio information 240.

FIGS. 28 and 29 show the updated results.

The contents shown in FIGS. 28 and 29 are obtained by multiplying each of the accumulated ratio information by a predetermined value according to each of the accumulated ratio information as carried out in the first exemplary embodiment.

Note here that in the reflection of accumulation results, the absolute value of the obtained ratio may be treated as a number of points. Thus, since points can be provided for each defect pattern based on reference information 238, search accuracy of document data 30 can be improved.

As a result, if a defect occurs, necessary document data 30 can be searched more exactly, thus enabling measures against the defect to be considered more smoothly.

### Third Exemplary Embodiment

Next, in a third exemplary embodiment, use of correlation information 33 is described.

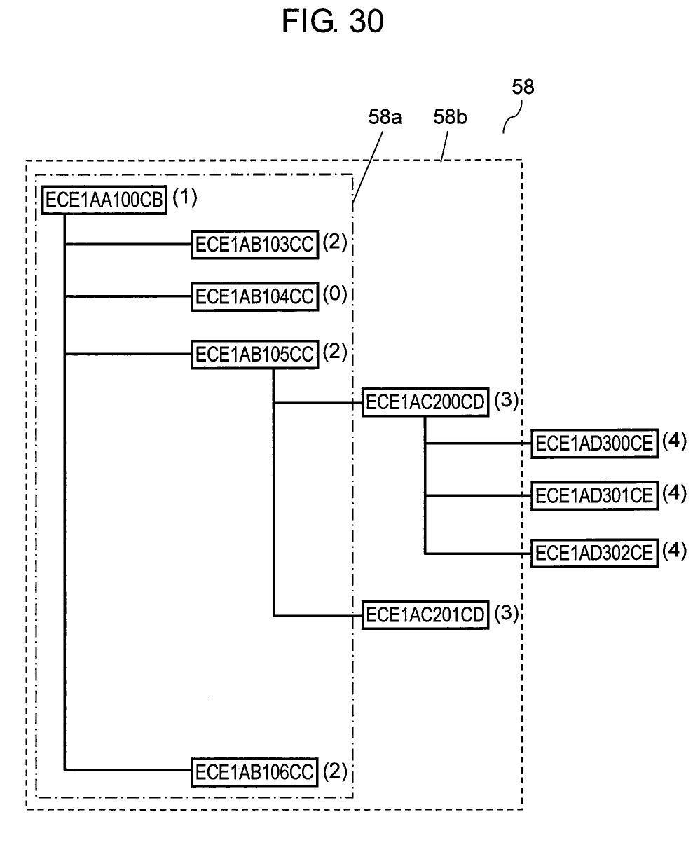

FIG. 30 is a hierarchy view showing correlation 58 of derivative products whose derivation source has a product number “ECE1AA100CB.” In the drawing, (n) at the right side of each product number represents a number of stages between the product numbers as described in the first exemplary embodiment. In FIG. 30, a number of stages based on the product number “ECE1AB104CC” is shown.

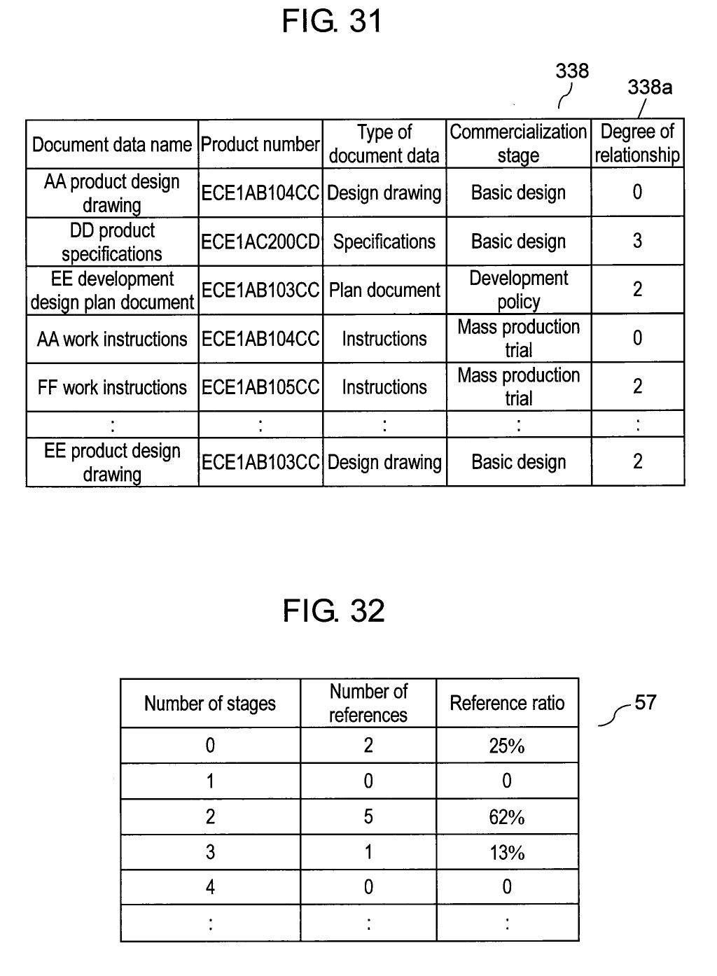

FIG. 31 shows results of search by using development document data management system 101 in accordance with one exemplary embodiment of the present invention. Reference information 338 shown in FIG. 31 shows results of search of products having correlation 58 shown in FIG. 30.

Note here that in “number of stages” column 338a, the number of stages from product number “ECE1AB104CC” is described.

Next, FIG. 32 shows mutual reference ratio information 57 calculated from reference information 338. Mutual reference ratio information 57 shows that when drawings within two stages are referred to, a cause of a defect regarding the product number “ECE1AB104CC” can be specified at about 90% accuracy.

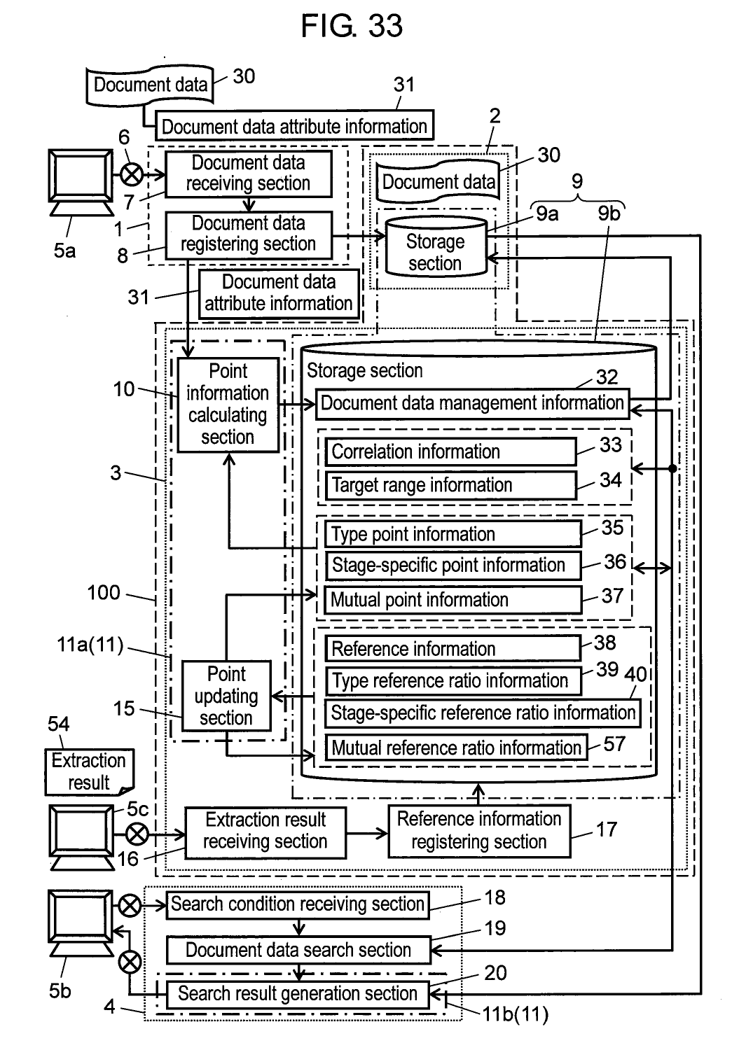

Therefore, when a defect regarding product number “ECE1AB104CC” occurs, as shown in FIG. 33, the following search can be carried out by using mutual reference ratio information 57 stored in storage section 9b.

Firstly, in order to specify the cause of a defect as effectively as possible, a search range is limited to search range 58a.

When appropriate document data 30 is not found, or in order to confirm whether or not search is carried out completely, document data 30 within three stages as search range 58b are searched.

Note here that search ranges 58a and 58b may be set by adjusting a predetermined number of stages according to the aim of the search.

Furthermore, when mutual reference ratio information 57 is used, if a defect occurs in one product, the range in which a similar defect may occur can be easily understood.

Specifically, from reference information 338 shown in FIG. 31 and mutual reference ratio information 57 shown in FIG. 32, it is shown that a defect occurring in the product number “ECE1AB104CC” is concentrated in the same stage (referred to as (2) at the side of product number) shown in FIG. 30.

Therefore, when a cause of a defect of a product number “ECE1AB104CC” is specified, it is possible to confirm whether or not a similar defect may occur in the same stage in advance.

As mentioned above, as is apparent from the description in the first to third exemplary embodiments, by using the exemplary embodiment of the present invention, by providing a unified index, that is, document data attribute information 31 to document data 30 when a product is developed, the following effects can be obtained.

Firstly, even when the contents of document data 30 are drawings, tables, or the like, the search target can be summarized systematically. Furthermore, such document data 30 are searched by using a unified index, that is, a point converted from various information of document data attribute information 31 without using an ambiguous index such as a keyword.

In other words, it is difficult to exactly search document data 30 that matches a target by an extraction method by using a coincident word or a synonym using a keyword including highly objective element of a searcher. In particular, when the targeted document data 30 includes only drawings and tables, it is difficult to carry out searching unitarily based on the character information.

Therefore, for example, when a defect caused by a circuit design occurs and specification mainly including character information and design drawing including drawings are extracted in order to take measures against the defect, it is possible to search necessary document data 30 more exactly in the exemplary embodiment of the present invention in which positioning of the specification and the design drawing is made in the development stages or the drawing is related to the other drawings, and the specification and the design drawing are weighed by an objective index such as a number, rather than the case in which a search is carried out by using a keyword and the like.

Furthermore, by feeding back the search results and updating the number as the search index, the search accuracy can be improved. In particular, when classification is carried out according to the defect state, more exact and quick search can be carried out.

Furthermore, when various product numbers are present, for example, OEM supply, in order to extract related products, it is possible to search more exactly and quickly when the target products are searched from the correlation showing the derivation state rather than by using the product number of product itself as a search index.

Moreover, when correlation information 33 is used, when a defect occurs in a product, since there is a possibility that products in the equal positioning in the development of the product may have the same defect, it is possible to verify in advance whether or not a defect occurs.

### INDUSTRIAL APPLICABILITY

A development document data management device, a development document data management system, a development document data management method, a program therefor, and a storage medium of the present invention enable extraction of target document data quickly by using an objective index like a number by providing the document data with points according to the positioning of each document data.

Therefore, when studies of element technology, scientific literatures and the like are searched, if they are in a field in which a unified index can be formed, exact search can be carried out.

In particular, the development document data management system can be embodied by using a computer, a document data registering device, a document data storing device, a document data management information storing device and a document data searching device can be embodied by operating a program on the computer.

Then, the program can be distributed via a storage medium such as CD-ROM, or a communication line.

Since the development document data management device and the development document data management system in accordance with the exemplary embodiment of the present invention are configured as mentioned above, documents can be extracted with respect to the registered document data more quickly and exactly.

1. A development document data management device comprising:
a storage section for storing:
a plurality of first document data on a first product; and
first document data attribute information including a commercialization stage indicating any one of two or more stages to develop the first product, and a type indicating which type of a plurality of types an aim of the first document data generated in the commercialization stage is related to, for each of the first document data,
a control section operating
so as to calculate a total point from a stage-specific point given to the commercialization stage and a type point given to the type based on the first document data attribute information, and to generate first document data management information for associating the total point with the first document data, and
so as to display results of search of the first document data management information based on a search condition when the search condition for searching the first document data is input in a predetermined order.

2. The development document data management device of claim 1,
wherein the storage section stores:
a plurality of second document data on a second product related to the first product;
second document data attribute information including a commercialization stage indicating any one of two or more stages to develop the second product, a type indicating which type of a plurality of types an aim of the second document data generated in the commercialization stage is related to, and a correlation indicating a mutual relation between the first product and the second product, for each of the second document data, and
the control section operates
so as to calculate a total point from the stage-specific point, the type point, and a correlation point given from the correlation based on the second document data attribute information, and to generate second document data management information for associating the total point with the second document data, and
so as to display results of search of the second document data management information based on the search condition in a search range set by the search condition and the correlation in a predetermined order.

3. The development document data management device of claim 1 or 2, further comprising:
an extraction result receiving section for receiving an input of one or more extraction results extracted from the results of search of the first or the second document data management information as reference information,
wherein the control section operates so as to update at least one of stage-specific point information including the stage-specific point and type point information including the type point based on the reference information.

4. The development document data management device of claim 3, wherein the control section operates so as to calculate an extraction frequency of the first or the second document data based on the reference information, and so as to update at least one of the storage-specific point information and the type point information according to the extraction frequency.

5. A development document data management system, comprising:
a document data registering device;
a development document data management device including a storage section and a control section; and
a document data searching device, which are connected to each other via a communication line,
wherein the document data registering device registers
a plurality of first document data on a first product; and
first document data attribute information including a commercialization stage indicating any one of two or more stages to develop the first product, and a type indicating which type of a plurality of types an aim of the first document data generated in the commercialization stage is related to, for each of the first document data;
the storage section stores the first document data and the first document data attribute information;
the document data searching device inputs a search condition for searching the first document data; and
the control section operates
so as to calculate a total point from a stage-specific point given to the commercialization stage and a type point given to the type, based on the first document data attribute information, and to generate first document data management information for associating the total point with the first document data, and
so as to display results of search of the first document data management information on the document data searching device based on the search condition in a predetermined order.

6. The development document data management system of claim 5,
wherein the document data registering device registers
a plurality of second document data on a second product related to the first product; and
second document data attribute information including a commercialization stage indicating any one of two or more stages to develop the second product, a type indicating which type of a plurality of types an aim of the second document data generated in the commercialization stage is related to, and a correlation indicating a mutual relation between the first product and the second product, for each of the second document data, and
the storage section stores the second document data and the second document data attribute information;
the control section operates
so as to calculate a total point from the stage-specific point, the type point, and a correlation point given from the correlation based on the second document data attribute information; and
so as to generate second document data management information for associating the total point with the second document data, and
further, so as to display results of search of the second document data management information based on a search condition in a search range set by the search condition and the correlation in a predetermined order.

7. The development document data management system of claim 5 or 6, further comprising:
an extraction result receiving section for receiving an input of one or more extraction results extracted from results of search of the first or the second document data management information as reference information,
wherein the control section operates so as to update at least one of stage-specific point information including the stage-specific point and type point information including the type point based on the reference information.

8. The development document data management system of claim 7,
wherein the control section operates so as to calculate an extraction frequency of the first or the second document data based on the reference information, and to update at least one of the stage-specific point information and the type point information according to the extraction frequency.

9. A development document data management method, comprising:
storing a plurality of first document data on a first product;
storing first document data attribute information including a commercialization stage indicating any one of two or more stages to develop the first product, and a type indicating which type of a plurality of types an aim of the first document data generated in the commercialization stage is related to, for each of the first document data;
calculating a total point from a stage-specific point given to the commercialization stage and a type point given to the type based on the first document data attribute information, and generating first document data management information for associating the total point with the first document data;
inputting a search condition for searching the first document data; and
displaying results of search of the first document data management information based on the search condition in a predetermined order.

10. The development document data management method of claim 9, further comprising:
storing a plurality of second document data on a second product related to the first product;
storing second document data attribute information including a commercialization stage indicating any one of two or more stages to develop the second product, a type indicating which type of a plurality of types an aim of the second document data generated in the commercialization stage is related to, and a correlation indicating a mutual relation between the first product and the second product, for each of the second document data;
calculating a total point from the stage-specific point, the type point and a correlation point given from the correlation based on the second data attribute information, and generating second document data management information for associating the total point with second document data; and
displaying results of search of the second document data management information based on the search condition within the search range set from the search condition and the correlation in a predetermined order.

11. The development document data management method of claim 9 or 10, further comprising:
inputting one or more extraction results extracted from results of search of the first or the second document data management information as reference information; and
updating at least one of stage-specific point information including the stage-specific point and type point information including the type point based on the reference information.

12. The development document data management method of claim 11, further comprising:
calculating extraction frequency of the first or the second document data based on the reference information, and
updating at least one of the stage-specific point information and the type point information based on the extraction frequency.

13. A development document data management program for allowing a computer to execute the development document data management method described in any one of claims 9 to 12.

14. A storage medium for storing a development document data management program for allowing a computer to execute the development document data management method described in any one of claims 9 to 12 and capable of being read by a computer.
